(19) United States
(12) Patent Application Publication
(10) Pub. No.: US 2011/0098910 A1
(43) Pub. Date: Apr. 28, 2011

(54) METHOD AND APPARATUS FOR INTELLIGENT GUIDANCE USING MARKERS

(75) Inventors: Anssi Saarimaki, Berlin (DE); Mikko Nirhamo, Berlin (DE); Vesa Luiro, Berlin (DE)

(73) Assignee: Nokia Corporation, Espoo (FI)

(21) Appl. No.: 12/603,894

(22) Filed: Oct. 22, 2009

(51) Int. Cl. G01C 21/36

(52) U.S. Cl. 701/200

(57) ABSTRACT

An approach is provided for providing navigational assistance using guidance markers. One or more parameters associated with a guidance marker are received. A score is determined for the guidance marker using the one or more parameters. The guidance marker is selected based, at least in part, on the score for use in navigating along a path. Further, at least one other score can be determined for at least one other guidance marker and the other score may be compared with the score. The selection can be based on the comparison. A starting point and a destination point can be received. Further, navigational assistance data may be determined based on the guidance marker, the starting point, and the destination point. The navigational assistance data can be caused to be presented on a device.

### BACKGROUND

Service providers and device manufacturers are continually challenged to deliver value and convenience to consumers by, for example, providing compelling network services, such as navigational services. Many navigational services are based on mapping databases with associated street names to provide routing functionality. Such approach may result in the user not following the specified route, in large part, because the user may not have any knowledge or familiarity with the particular street names. That is, these traditional routing services may be confusing if the users lack orientation knowledge on the route.

### SOME EXAMPLE EMBODIMENTS

According to one embodiment, a method comprises receiving one or more parameters associated with a guidance marker. The method also comprises determining a score for the guidance marker using the one or more parameters. The method further comprises selecting the guidance marker based, at least in part, on the score for use in navigating along a path.

According to another embodiment, an apparatus comprising at least one processor, and at least one memory including computer program code, the at least one memory and the computer program code configured to, with the at least one processor, cause, at least in part, the apparatus to receive one or more parameters associated with a guidance marker. The apparatus is also caused to determine a score for the guidance marker using the one or more parameters. The apparatus is further caused to select the guidance marker based, at least in part, on the score for use in navigating along a path.

According to another embodiment, a computer-readable storage medium carrying one or more sequences of one or more instructions which, when executed by one or more processors, cause, at least in part, an apparatus to receive one or more parameters associated with a guidance marker. The apparatus is also caused to determine a score for the guidance marker using the one or more parameters. The apparatus is further caused to select the guidance marker based, at least in part, on the score for use in navigating along a path.

According to another embodiment, an apparatus comprises means for receiving one or more parameters associated with a guidance marker. The apparatus also comprises means for determining a score for the guidance marker using the one or more parameters. The apparatus further comprises means for selecting the guidance marker based, at least in part, on the score for use in navigating along a path.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing navigational assistance using guidance markers, according to one embodiment;

FIG. 2 is a map diagram capable of illustrating navigational guidance provided by the system, according to one embodiment;

FIG. 3 is a diagram of the components of a guidance marker assistance module, according to one embodiment;

FIG. 4A is a flowchart of a process for selecting a guidance marker for navigating along a path, according to one embodiment;

FIG. 4B is a diagram showing parameters for evaluating the guidance markers, according to one embodiment;

FIG. 5 is a diagram of a user interface utilized in the processes of FIGS. 4 and 5, according to one embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for providing navigational assistance using guidance markers are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

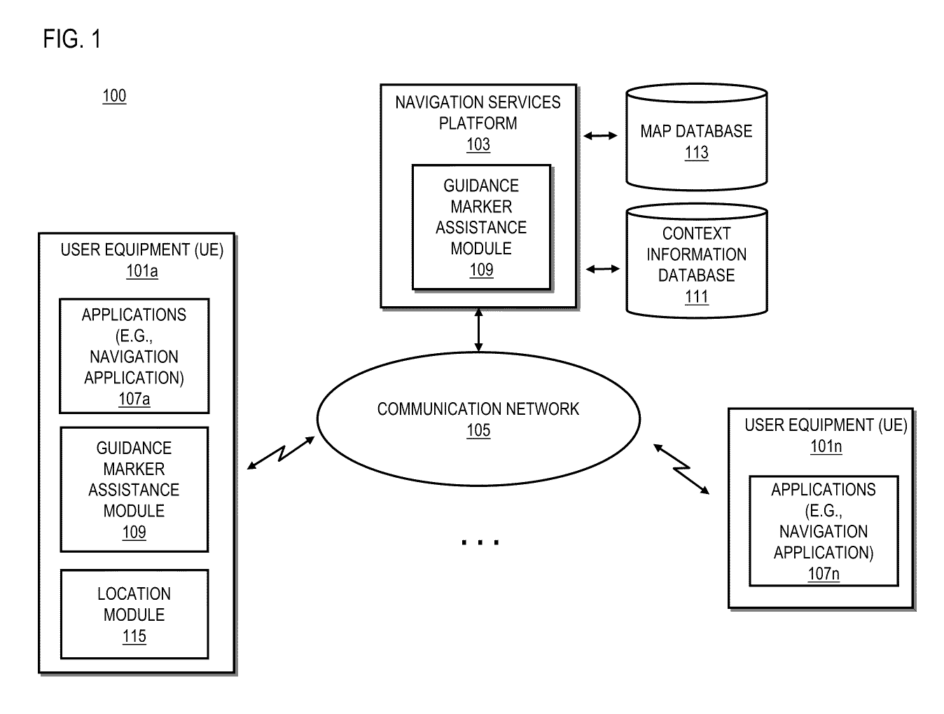

FIG. 1 is a diagram of a system capable of providing navigational assistance using guidance markers, according to one embodiment. As mentioned, navigational services rely on map interfaces and street names to convey presentations of the navigational services to users. As such, these users are provided with maps to help present the navigational services (e.g., path routing). However, such maps generally do not include information for orienting the user, as to provide user context for using the map. In some scenarios, the user may exit an unknown location (e.g., a metro station or a mall) and may not know how the user is oriented relative to the user's location on the map. Moreover, in other scenarios, the map presentation may be incomplete because in certain locations street names are not commonly used to provide directions because the street names may be difficult to see or determine (e.g., because the street sign is inadequate) by the user.

To address this problem, a system 100 of FIG. 1 introduces the capability to provide navigational assistance using guidance markers. A user can utilize a UE 101 to receive navigational services from a navigation services platform 103 via a communication network 105. The UE 101 may utilize a navigation application 107 to obtain the services. Moreover, the navigation application 107 may be utilized to provide navigational guidance without a connection to the navigation services platform 103. A guidance marker assistance module 109, which may executed on the UE 101 or the navigation services platform 103, may be used to determine navigational assistance based on guidance markers. In other words, the assistance module 109 can introduce guidance markers into navigational instructions, either to supplement the standard map-based instructions or replace such instructions selectively or entirely. In certain embodiments, the term “guidance marker” refers to visual indicators that may be used to provide assistance in navigation. In some exemplary embodiments, guidance markers may include landmarks (e.g., famous buildings, tall buildings, museums, churches, monuments, statues, bridges, overpasses, points-of-interest (POIs), parking areas, railways, parks, rivers, oceans etc.), atmospheric markers (e.g., the sun, the moon, bright stars, etc.), and road markers (e.g., roads (e.g., one way roads), crosswalks, traffic events (e.g., road work, congestion), traffic lights, etc.). Assistance can be provided by supplying directions in relation to the guidance markers (e.g., walk towards the monument, turn left at the POI, etc.).

Moreover, because there may be a number of different guidance markers that can be applied, determining which markers are more effective is useful. According to certain embodiments, various guidance markers may be candidates for navigational use and may be prioritized based on scores assigned to the guidance markers. Furthermore, these assigned scores can be determined based on scores of individual parameters of the guidance markers. In certain embodiments, the term “parameters” refers to attributes of a guidance marker that may be used to determine how beneficial a guidance marker would be in a contextual situation. Individual parameters that can be scored may include a distance parameter, a visibility parameter, an obstruction parameter, a path parameter, a combination thereof, etc. The distance score can be determined by an analysis of how far the guidance marker is from the user location. Further, the visibility score may be based on an analysis of how identifiable the guidance marker is, which can be a determination made based on the size of the guidance marker, distinctiveness of the guidance marker, weather, distance, and/or other factors. Moreover, the obstruction score may be determined by an examination of whether something is blocking view of the guidance marker from the UE 101 location, this determination may be based on the size of the guidance marker and the size of the objects between the guidance marker and the UE 101. The path score may be based on an analysis if the guidance marker is on a navigational path. The scoring of these parameters can include factors that include dynamic content such as weather, traffic, or other event information.

In one embodiment, contextual information for determining scores can be stored in a context information database 111 that can be accessed directly or indirectly by the guidance marker assistance module 109. The contextual information can be used to score the guidance markers based on the parameters. In certain embodiments, the context information can include weather information, sun location information, lunar information, and etc. Some of the information stored in the context information database 111 can be dynamically changing.

In one embodiment, the platform 103 interacts with a map database 113, which can store mapping information as well as information about some or all of the guidance markers. Such information can include the location (e.g., global positioning system (GPS) coordinates, longitude, latitude, altitude etc.) of the guidance markers, sizes (e.g., length, width, height, etc.) of the guidance markers, locations and sizes of other items (e.g., obstructions) on a map, distances between guidance markers, attributes (e.g., color, traffic direction of a street, number of lanes in a roadway, etc.) of guidance markers and other like information. Moreover, the information may include mapping values of the location information of the guidance markers to other types of location based information (e.g., cellular identifier (CellID) information). The map database 113 can be created by adding three dimensional features to a base two dimensional map. This may include adding altitude parameters to the map. Additionally, guidance markers can be added to the map along with location, size, and other attributes describing the guidance markers. The guidance markers and guidance marker information can be added by processing and appending information from other databases (e.g., phonebooks, other mapping databases, POI databases, etc.). Some guidance markers may be dynamic, such as the sun or moon, which has varying positions depending on the time of day. These guidance markers may be stored with functions or other information used to determine the location, size, or other dynamic attributes of the guidance marker. In some embodiments, the functions can call routines to retrieve additional information from other databases (e.g., a context information database 111).

As shown, the system 100 provides a navigation services platform 103, which includes a guidance marker assistance module 109. By way of example, the UE 101 requests guidance information from the navigation services platform 103, which can process the request and provide guidance information to the UE 101. In processing the request, the navigation services platform 103 may utilize the map database 113 and the context information database 111.

According to certain embodiments, the UE 101 uses the navigation services platform 103 as a conduit to receive information from the context information database 111 and/or the map database 113. In these scenarios, the UE 101 may itself include a guidance marker assistance module 109.

The UE 101 can be any type of mobile terminal, fixed terminal, or portable terminal including a mobile handset, station, unit, device, multimedia computer multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

In one example, the UE 101 includes a location module 115 that can utilize anyone or more technologies for determining the UE's location. For instance, the location can be determined by a triangulation system such as a global positioning system (GPS), Assisted-GPS (A-GPS), Cell of Origin, WLAN triangulation, or other location extrapolation technologies. Standard GPS and A-GPS systems can use satellites to pinpoint the location of a UE 101. A Cell of Origin system can be used to determine the cellular tower that a cellular UE 101 is synchronized with. This information provides a coarse location of the UE 101 because the cellular tower can have a unique cellular identifier (CellID) that can be geographically mapped. The location module 115 may also utilize multiple technologies to detect the location of the UE 101. In other embodiments, the location module 115 may query the user to enter a location of the user. Moreover, the location module 115 may use an interactive system of asking the user if the user has reached a certain point (e.g., on a path). When a user enters information leading to a determination that the certain point has been reached, the location module 115 can assume that the user is at that location.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

Moreover, the UE 101 and navigation services platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

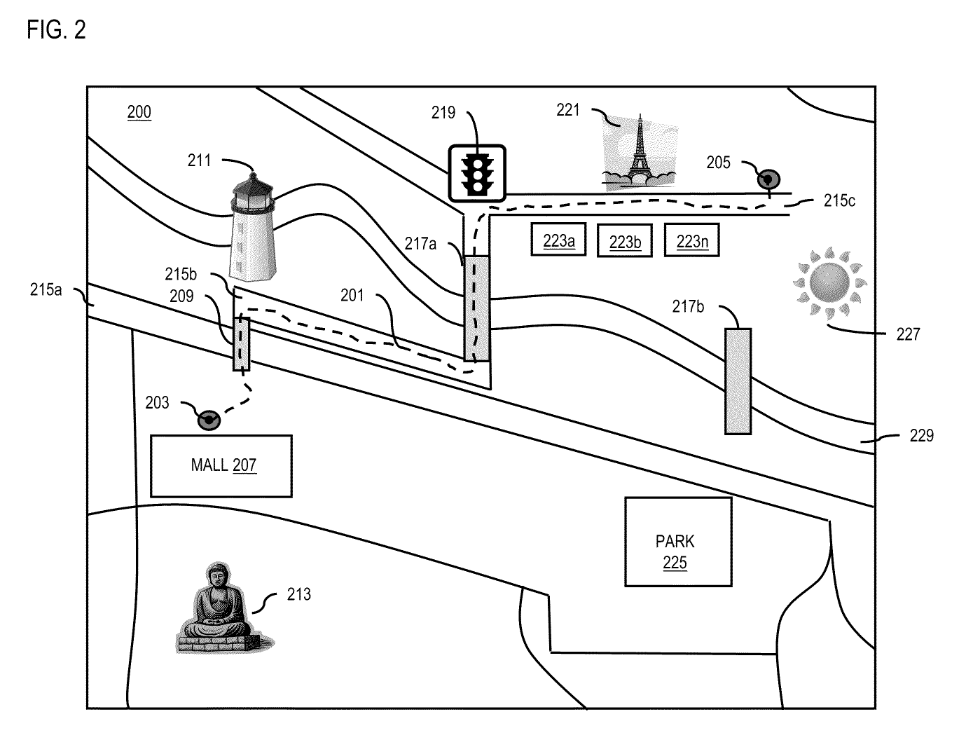

FIG. 2 is a map diagram capable of illustrating navigational guidance provided by the system, according to one embodiment. The diagram 200 shows a path 201 determined by a guidance marker assistance module 109 between a starting point 203 and an ending point 205. The user starts a navigation application 107 that utilizes the guidance marker assistance module 109 on the user's device, e.g., UE 101, outside of a mall 207 to determine the path 201. The navigation application 107 determines the starting point either from a user input or using location determination technology (e.g., GPS, Assisted GPS, Cell of Origin, WLAN triangulation, etc.). Moreover, the location determination technology used can output an accuracy value. For example, GPS accuracy may be based on the number of satellites visible, WLAN triangulation accuracy may be based on the number of wireless networks known by a WLAN triangulation database (not shown) that can be accessed by the UE 101. GPS and WLAN triangulation techniques are usually more accurate than a Cell of Origin technology. Next, the user can select the ending point. The guidance marker assistance module 109 then uses a map database 113 and context information database 111 to determine which guidance markers can be used to assist in route information. The guidance marker assistance module 109 determines that an overpass 209, a lighthouse 211, the mall 207, a statue 213, roadways 215a-215c, a bridges 217a, 217b, a traffic light 219, a landmark 221, houses 223a-223n, a park 225, the sun 227, and a river 229 are guidance markers that represent candidates that may be used in providing navigational assistance to the user. The guidance marker assistance module 109 can make this determination based on a distance of the guidance markers from the location of the UE 101.

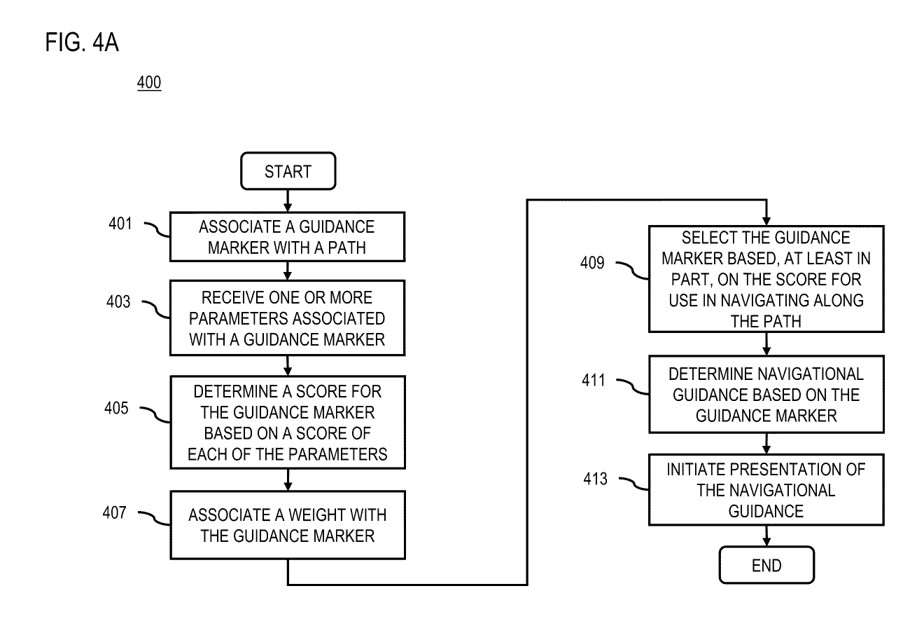

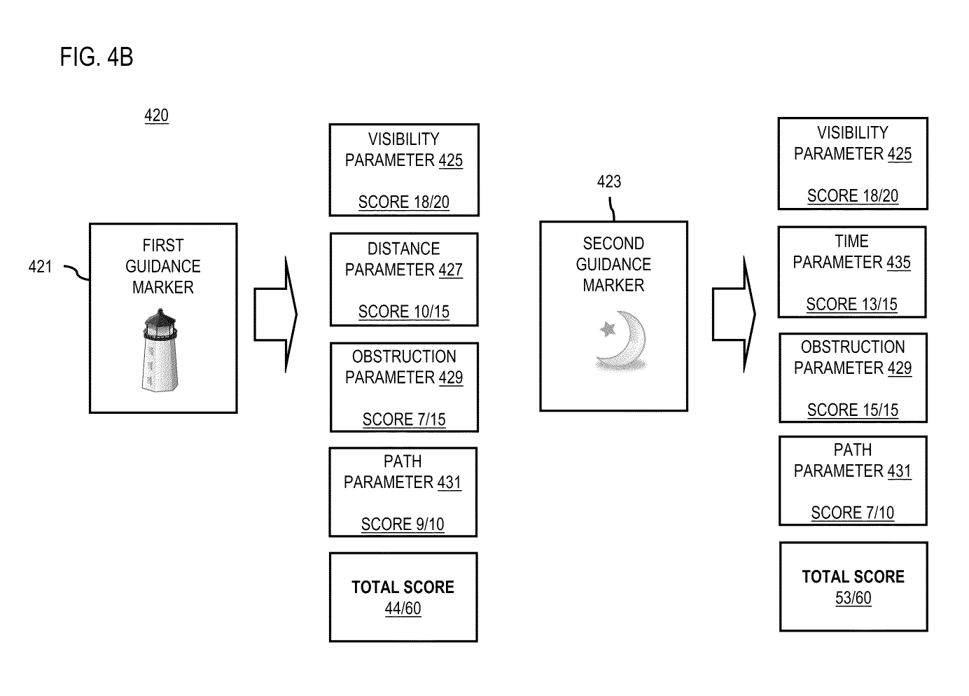

Each of the guidance markers determined to be candidates can be assigned a score as later detailed in the processes of FIG. 4 based on criteria associated with each guidance marker. In certain embodiments, the criteria includes one or more of location accuracy, visibility of the guidance marker (e.g., how identifiable the guidance marker is), an obstruction value determining whether one or more objects is between the UE 101 and the guidance marker, a distance of the guidance marker from the UE 101, a distance of the guidance marker to the UE 101, a distinctiveness score based on the amount of similar guidance markers in the area, a path value that represents a relationship between the guidance marker and the navigational path. The scoring may account for dynamic factors (e.g., weather, time, etc.). For example, a visibility score of the sun may be lessened more on a cloudy day than the visibility score of a landmark (e.g., the Washington monument). Further, once the scores for the guidance markers are formulated, the scores can be weighted based on a specific usage pattern such as a type of travel (e.g., car, walking, biking, etc.) or types of interfaces used (e.g., visual cues only, audio cues only, etc.). For example, in biking or car navigation, the user may prefer to have only audio cues. In this example, more generic guidance markers (e.g., a bridge, a tunnel, a park, a church, etc.) can be used to provide guidance information because the generic guidance markers are simple to describe with audio. Moreover, a weight may be dynamically changed based on user movements. For example, if two guidance markers were chosen to provide assistance to the user and the user starts moving in a wrong direction, the guidance can be recalculated by assigning the two guidance markers a lower priority dynamic weighting.

Once the guidance markers are scored, guidance markers from the pool of candidates can be selected to provide orientation assistance. In one embodiment, the guidance marker or markers with the most optimal score(s) (e.g., highest score(s)) can be selected for assistance. In another embodiment, during the selection process, the types of guidance markers may be selected based on a category of the guidance marker. For example, categories may include types of landmarks, types of atmospheric markers, types of road markers, etc. When using two or more guidance markers, variety in selection may be preferred by the user. Thus, there may not be a need to use markers that overlap in category type (e.g., a user may not wish to be provided assistance based on two bridges or two landmarks, thus only one should be used).

In the scenario of the path 201 taken by the user, when the user, at the starting point 203, initiates the navigation application 107, the navigation application 107 looks for available guidance markers. The navigation application 107 finds the guidance markers listed above. Then, the guidance markers are scored. Initially, the scoring determines that the mall 207, lighthouse 211, and overpass 209 are selected to provide assistance. Assistance can be in the form of walk towards the lighthouse, walk towards the overpass 209, and walk away from the mall 207. Initially, the Park 225 is assigned a low score because it has a great distance and low visibility from the starting point 203. The statue 213 is also assigned a low score because its view is obstructed by the mall. At a later point along the path, when the user reaches roadway 215b, the user is provided information to turn right on the roadway, walk towards a bridge 217a, and walk with the river 229 on the left hand side. The scores can be dynamically calculated along the path 201 and new assistance can be determined either periodically or when the user reaches certain points along the path. For example, certain points can be when the user needs to change a direction of movement. In one example, the user reaches the traffic light 219 and new guidance information is scored and provided for the user. At this point, the best scoring guidance markers from the pool of candidates may be the sun 227, a roadway 215c, and the traffic light 219. The guidance can be provided as turn right at the traffic light 219 onto the roadway 215c, then walk towards the landmark 221 along the roadway 215.

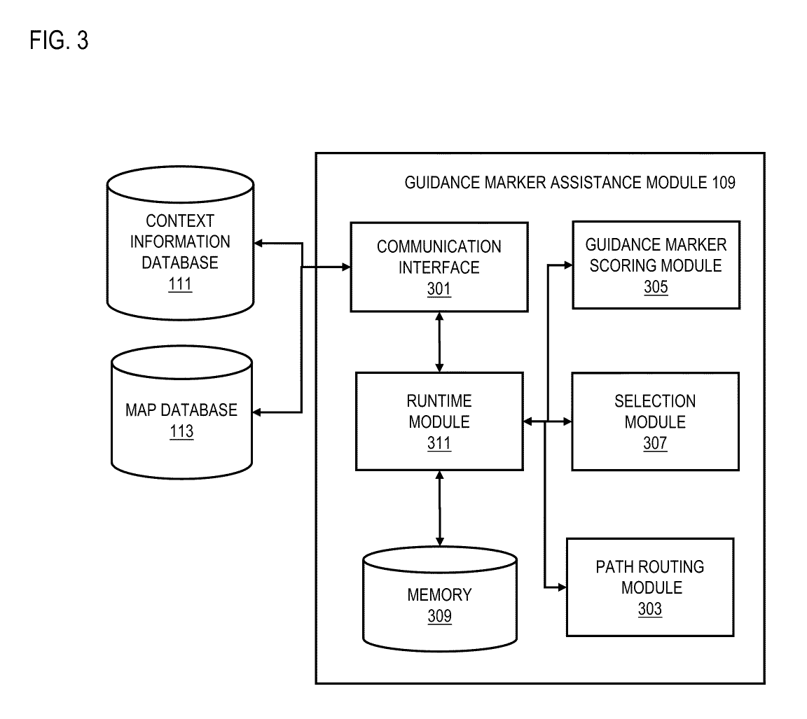

FIG. 3 is a diagram of the components of a guidance marker assistance module 109, according to one embodiment. By way of example, the guidance marker assistance module 109 includes one or more components for providing navigational assistance to a user via guidance markers. It is contemplated that the functions of these components may be combined in one or more components or performed by other components of equivalent functionality. In this embodiment, the guidance marker assistance module 109 includes a communication interface 301, a path routing module 303, a guidance marker scoring module 305, a selection module 307, a memory 309, and a runtime module 311. The guidance marker assistance module 109 may be on the navigation services platform 103 or the UE 101.

In one embodiment, the guidance marker assistance module 109 includes a communication interface 301. The communication interface 301 can be used to communicate with a UE 101, a navigation services platform 103, a context information database 111, or a map database 113. Certain communications can be via methods such as an internet protocol, messaging, or any other communication method (e.g., via the communication network 105). Other communications may be via other data interfaces, such as a bus for fiber channel connections to a database. In some examples, the UE 101 can send a query to a guidance marker assistance module 109 on the navigation service platform 103 via the communication interface 301. The guidance marker assistance module 109 may then send a response back via the communication interface 301.

In another embodiment, the guidance marker assistance module 109 includes a path routing module 303. The path routing module 303 can determine one or more routes from one or more places to one or more places. The path routing module 303 can receive start and end points for the path via the communication interface 301 and runtime module 311. Then, the path routing module 303 can retrieve a map of the area surrounding the start and end points from a map database 113. In certain examples, the map database 113 may be a part of the guidance marker assistance module 109. The path routing module 303 can then calculate a route based on various algorithms. The path routing module 303 may additionally be able to determine the path based on a type of travel of the user (e.g., pedestrian walking, biking, automobile, etc.). For example, this can be used to determine that certain paths may become available when walking or biking, but may not be open while in an automobile. Moreover, the path routing module 303 may be able to route or reroute paths based on guidance markers. For example, if there are insufficient guidance markers available along a determined path to provide ample assistance to a user, the path routing module 303 may reroute the path to determine a new path with sufficient guidance marker navigational assistance.

In one embodiment, the guidance marker assistance module 109 includes a scoring module 305. The scoring module 305 can determine guidance markers along the paths generated by the path routing module 303. Information about the location of the guidance markers may be stored in a map database 113. Then, the guidance marker scoring module 305 can score and weight the guidance markers as described in the scenario of FIG. 2 and further described in FIG. 4. The score can be determined partially or wholly based on context information from a context information database 111. The context information database 111 can include information about weather, traffic, or other real time conditions that may affect the scoring of one or more guidance parameters. The guidance marker scoring module 305 can then update the scoring, either periodically or based on an event (e.g., reaching a certain point of the path or straying off of the determined path). The scores can then be stored in a memory associated with the guidance marker assistance module 109.

In another embodiment, the guidance marker assistance module 109 includes a selection module 307 for determining which one or more guidance markers are used to provide navigational assistance from the pool of candidates of guidance markers. The selection can be based on the computed scores for the respective markers. Under one scenario, the guidance markers with the best scores are selected. In another scenario, the selection can be based on categories. For example, the best scoring guidance markers are classified into categories of types of guidance markers (e.g., landmark, road marker, atmospheric mark, etc.) or types of advisory information provided to the user such as a moving towards a beacon (e.g., walk towards a landmark, walk towards a waterway, etc.), moving along a marker (e.g., walk with roadway on left hand side, walk with river on right hand side, etc.), or other types of advisory information. Then, duplicates of same types of guidance markers can be removed from consideration as a candidate if there is a guidance marker that has scored higher.

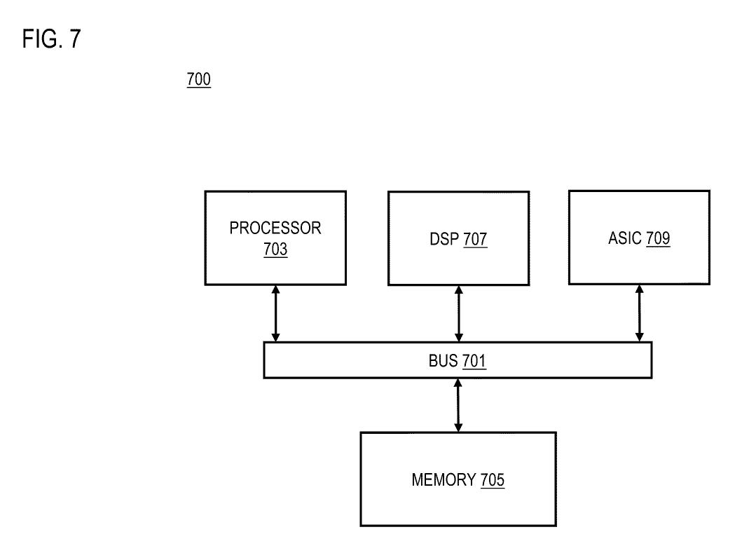

FIG. 4A is a flowchart of a process for selecting a guidance marker for navigating along a path, according to one embodiment. In one embodiment, the runtime module 311 performs the process 400 and is implemented in, for instance, a chip set including a processor and a memory as shown FIG. 7. In one embodiment, a user of a UE 101 activates a navigation application 107 to receive navigation guidance. The navigation application 107 can utilize a guidance marker assistance module 109 resident on the UE 101 or resident on a navigation services platform 103 to provide guidance marker assistance to the user. The UE 101 may have a location module 115 employing any one of the location determination schemes described earlier to determine the location of the user; for example, the location module 115 can include a GPS receiver. The user can specify, via a user interface of the UE 101, a destination and/or a starting location. The starting location may be determined by the location module 115, if the UE 101. Alternatively, the starting location can be entered manually by the user, or determined on the network side. Thereafter, the path routing module 303 determines a path from the starting location to the destination location.

At step 401, a guidance marker is associated with the path. One or more guidance markers may be associated with the path by the runtime module 311. These associated guidance markers can be considered candidates for providing navigational assistance. The guidance marker scoring module 305 may be used by the runtime module 311 to determine the one or more guidance markers from a map database 113. The runtime module 311 may determine available guidance markers based, at least in part, on a distance from the starting location. For example, guidance markers available within a predetermined range (e.g., 200 meters, 500 meters, 2000 meters, etc.) may be categorized as available guidance markers for providing guidance.

Then, at step 403, the runtime module 311 receives one or more parameters associated with the guidance marker. The parameters may be used to determine a score associated with the guidance marker. Different guidance markers may have different parameters associated with the guidance marker. Moreover, different guidance markers may include one or more of a visibility parameter, a distance parameter, an obstruction parameter, a path parameter, a time parameter, etc. Some parameters may not be applicable to some guidance markers and is thus not used to determine a score for those particular guidance markers.

Then, at step 405, the runtime module 311 determines a score for the guidance marker using an algorithm to calculate a total score based on a score of each of the parameters applicable to the guidance marker. According to certain embodiments, the score can be computed for each of the parameters based on additional factors, e.g., user preference, etc. The individual parameters can be computed based, at least in part, on the different factors and the runtime module 311 may track the total score and the total available score for each parameter. Different types of guidance markers may have different total available scores as a total and for each parameter. Moreover, some of the factors may be based on dynamic content downloaded from the context information database 111.

A visibility parameter can include how visible and/or identifiable the guidance marker is. This can be based factors such as the size and type of the guidance marker as well as the types of other guidance markers in the area. For example, if there are 5 bridges in the area of a bridge guidance marker, the visibility score of the bridge guidance marker may be lowered because it is less identifiable than a single bridge in the area would be. However, if the bridge was a famous landmark, a distinctive color, or otherwise more identifiable (e.g., has 10 lanes), the visibility score may be higher. Moreover, the visibility score may be determined based on factors including context information that can affect visibility, such as weather (e.g., fog, clouds, etc.), time (e.g., a lighthouse may display a beacon light at night). Clouds may affect the visibility of certain guidance markers (e.g., the sun) more than other guidance markers (e.g., a small building), and thus the cloud visibility factor may have more influence over the visibility score of the certain guidance markers. Thus, each guidance marker may have certain types of context information associated with the guidance marker that can affect the visibility parameter. Moreover, the context information may affect the score of different guidance markers differently based on the amount the context information affects the visibility of the particular guidance marker. Additionally, the visibility score can be partially based on a factor of an accuracy of the location of the user. For example, different location extrapolation technologies have different accuracies. This accuracy can be represented as an accuracy range (e.g., a value in meters). If the accuracy range is more than a predetermined tolerance (e.g., 50 meters) a greater score may be assigned to larger guidance markers and a lower score may be assigned to smaller guidance markers.

A distance parameter can be used to determine the distance score of the guidance marker to the user location. The distance score may be reduced the farther away the guidance marker is. The size of the guidance marker may be used to determine a scale for the determination of the score, where the closer the guidance marker, the higher the score. A larger sized guidance marker may have a lower reduction in distance score per distance away from the user because the distance of a larger sized guidance marker may be less important than the distance of a smaller sized guidance marker. For example a smaller sized guidance marker at a particular distance may not be visible to the user, but a larger sized guidance marker at the same distance may be visible to the user. Some guidance markers (such as the sun, the moon, etc.) may not include a distance parameter or the distance parameter may be scored as a 0 out of the total available score or a maximum out of the total available score based on a default setting of the guidance marker.

An obstruction parameter may be used to determine a level of obstruction of the guidance marker from view. The lower the amount of obstruction (e.g., buildings partially or completely blocking the guidance marker) the greater or better the score. Obstructions can be based on factors such as on other guidance markers, elevation of the ground (e.g., a hill in between the guidance marker and the user), or other known objects (e.g., houses, other buildings, or land masses) that may be blocking view of the guidance marker. Known objects can be stored in the map database 113. Larger guidance markers may be partially blocked, but still visible. An obstruction score can be computed based on the ratio of visible parts of the guidance marker to the total size of the guidance marker. Moreover, obstruction scores may be based on context information factors such as weather data. The context information may be dynamically changing. For example, clouds may partially obstruct guidance markers that are high.

A path parameter may be utilized to determine a score based on whether the guidance marker is along the routed path. This can be determined by comparing the location of the guidance marker to the routed path. The distance from the path can also be utilized to adjust the path score. The better guidance can be accurately provided as directions, from the UE 101, the better the path score. The direction and the face of the guidance marker showing in relation to the path may be used as factors to determine how well guidance can be provided using the guidance marker on the path score. In one example, the guidance marker may score higher on a path score if the guidance marker is on the path (e.g., visible while moving forward along the path), which can be considered good. In another example, if a small landmark guidance marker (e.g., a building) is to the side of the path, it may receive a low path score and be considered bad because it may be difficult to provide directions associated with the small landmark guidance marker. In a further example, a large landmark guidance marker (e.g., a river) on the side of the path may receive a high path score because it may be easier to provide directions (e.g., walk with river on left hand side) based on the large landmark. However, the same large landmark guidance marker may receive a lower path score if it shows a different face to the user along the path (e.g., the river runs diagonally away from the path). In a further example, the guidance marker may be scored neutrally if the guidance marker is not along the path, but behind the path. In this example, it may not be as beneficial as a guidance marker on a path that can be seen while moving forward, however it can be useful to tell the user to move away from the guidance marker. The guidance marker's path rating may also be based on a time factor. For example, the sun may be better used to provide orientation in the morning and evening, when the sun is oriented towards a direction of the sky such as east or west.

A time parameter may be utilized for some guidance markers. For example, certain guidance markers (e.g., the sun) may be more useful during certain times (e.g., morning and evening, when the sun is associated with a direction (east or west)), less useful during other times (e.g., noon), and not applicable at other times (e.g., after sunset, before sunrise, etc.). In certain scenarios, the score can be negative. Time can also be taken into consideration for visibility scores as a dynamic parameter.

The scores of the parameters of the guidance marker can then be computed into a total score. In some embodiments, the total score can be a sum of the scores for each of the parameters associated with the guidance marker. As described above in the scoring of individual parameters, one or more of the parameter scores can be based, at least in part, on guidance marker context information. Moreover, a score for other guidance markers such as the second guidance marker 423 may also be computed.

In one embodiment, at step 407, the runtime module 311 associates a suitability weight with the guidance marker. The suitability weight can be used to modify the scores (e.g., by multiplying the suitability weight to the raw scores) and can be based on usage patterns of the user. In one embodiment, the usage patterns can be based on a type of travel (e.g., pedestrian walking, bicycle, car navigation, etc.) of the user. Thus, in certain embodiments, the suitability weight is a factor in determining the suitability of using the guidance marker for a specific type of travel. Different usage patterns can affect what guidance information should be presented to the user because it is different to provide instructions to a user using a car than a user walking The type of travel may be important because the mode of guidance can be changed based on the type of travel. For example, guidance for a pedestrian may include visual cues as well as audio cues, but guidance for a user on a bicycle or as the driver of an automobile may be limited to audio cues only. The user may also request a particular type or types of cues be used to provide information. Suitability weights may be provided based on guidance markers based on how well the guidance marker and assistance provided by the guidance marker can be adapted to the mode of providing cues. For example, in the case of audio guidance, guidance markers may be assigned more weight if the guidance marker is simple to describe (e.g., a bridge, tunnel, park, church, etc.). Using audio guidance, it may be more difficult to provide output for famous landmark guidance markers or road attributes (e.g., number of lanes of a road) because additional vocal information may need to be gathered and stored to describe the attributes or famous landmark. A problem with gathering the additional vocal information is that it may be unlikely to be reused. In another embodiment, the weightings can be recalculated based on user movement by using machine learning algorithms based on previously provided orientation guidance. In this embodiment, the runtime module 311 learns from movements of the UE 101 of the user to determine which guidance information has been successfully followed. For example, if the user moves in an opposite or incorrect direction after being provided guidance, the runtime module 311 can adjust the weights on the guidance markers or guidance marker types used to provide the guidance information.

Then, at step 409, the guidance marker is selected based, at least in part, on the score (weighted or unweighted) for use in navigating along the path. The guidance marker, once scored and/or weighted, can be compared with other guidance markers (e.g., at least one guidance marker) that are considered candidates and also scored to determine which guidance marker(s) should be used for user assistance. In one embodiment, the guidance marker(s) with the best score(s) (e.g., the marker(s) with score(s) that exceeds other scores) are selected based on the comparison. In another embodiment, the guidance marker(s) with the best scores in certain categories are selected. For example, it may not be optimal to provide information about two guidance markers that are very similar (e.g., two buildings directly on the path) even if two guidance markers score best. As such, it may be more optimal to provide information about the higher scored guidance marker and another guidance marker (e.g., a river) that provides a different type of information (e.g., walk towards Building guidance marker with river on left hand side). Thus, guidance markers in the same categories or that have certain similarities are considered duplicates and are removed from consideration if there is a higher scoring guidance marker in the same category. In certain scenarios, the guidance markers require a predetermined qualifying score to be used for navigational guidance. In these scenarios, if none of the guidance marker candidates along the path meet the qualifying score, the route may be recalculated by the path routing module 303 based, at least in part, on the guidance marker or other guidance markers (e.g., the pool of guidance marker candidates may be increased or the route can be recalculated to be along current guidance marker candidates) to determine another path. Scores associated with guidance markers may increase above the threshold qualifying score based on the other path.

At step 411, navigational guidance is determined based on the guidance marker. This step can occur before or after the selection. If the navigational guidance is determined before the selection, it can be used for selection. If the navigational guidance is determined after the selection process, the selection can be filtered and recalculated based on the navigational guidance provided. Navigational guidance may include an indicator describing the guidance marker and a relationship indicator describing a relationship (e.g., a geographic relationship, a spatial relationship, etc.) between the user's current location and the guidance marker.

Then, at step 413, a presentation of the selected navigational guidance is caused to be provided to the user by the runtime module 311. The presentation can be multimodal. The mode of presentation can be based on a user input or a type of travel. For example, one mode of presentation may be auditory. In this example, the guidance marker is indicated by using descriptive words (e.g., a guidance marker type (e.g., bridge), an attribute of the guidance marker (e.g., color), etc.) and the relationship may be described as towards, away, left hand side, right hand side, under, over, or other spatial or geographic term. Moreover, in some embodiments, the presentation can include a visual component. A visual component may include a map interface that can include the guidance markers and/or the location of the user. Moreover, the visual component may include a text interface to provide the auditory cues.

According to the above approach, users can be provided information about the guidance markers on a path that can be used to assist the user in orienting the user to follow the path. By using guidance markers, there can be less need for a user to struggle to determine an orientation to follow a path. Because there is less need to repeatedly review path directions to determine orientation, the UE 101 can go into a mode of operation that allows for a screen associated with the UE 101 to be shut off to save power consumption.

FIG. 4B is a diagram showing parameters for evaluating the guidance markers, according to one embodiment. As an example, a first guidance marker 421 is the lighthouse 211 of FIG. 2. For the purposes of illustration, the total score values can range to some maximum value—e.g., 60, whereby each of the parameters can have different maximum values (depending on the weighting). The lighthouse 211 may have a visibility parameter 425, a distance parameter 427, an obstruction parameter 429, and a path parameter 431 associated with the lighthouse 211 and include scores associated with the parameters. This type of guidance marker 421 may have maximum scores of maximum visibility score of 20, maximum distance score of 15, maximum obstruction score of 15, and a maximum path score of 10. The runtime module 311 may receive context information from a context information database 111 to determine that it is night time and the weather is clear. Based on this information, the lighthouse 211 may receive a visibility score of 18/20 because factors that the particular lighthouse 211 is distinctively colored red, is not nearby other lighthouses 211, is large, has a bright beacon light at night, and the weather is clear. Next, the lighthouse 211 may also be assigned a distance score of 10/15 because the lighthouse is within a certain distance from the user. The distance score may also be based on the size of the lighthouse 211. Moreover, the lighthouse 211 may receive an obstruction score of 7/15 based on, for example, elevation factors (e.g., the base of the lighthouse 211 is at a lower region near a river 229 and only a portion of the lighthouse 211 can be seen by the user at point 203) and other objects (e.g., an overpass 209) obstructing the view. The score can be determined by determining a ratio of how blocked the lighthouse 211 is from the user perspective. The lighthouse 211 may also receive a path score of 9/10 because the lighthouse 211 can be seen while traveling the path 201. The total score 435, 44/60, of the lighthouse 211 can be the sum of the visibility score, distance score, obstruction score, and path score.

Other guidance markers, such as the second guidance marker 423 can be scored in a similar manner as the lighthouse 211 based on parameters associated with the other guidance markers. In some embodiments, the second guidance marker 423 may have different parameters to base a total score on, such as a time parameter 435 instead of a distance parameter for a celestial guidance marker such as the moon or sun. In one embodiment, the second guidance marker 423 is the moon. In this embodiment, it is determined that the moon receives a visibility score of 18/20 because it is a clear night and the moon is almost full, a time score of 13/15 because it is nighttime and the moon is not new, an obstruction score of 15/15 because there are no objects obstructing view to the moon, and a path score of 7/10 because the moon is behind the path. The second guidance marker 423 thus receives a score of 53/60.

After the scoring process, the guidance markers can be selected for use in guidance. In one example, one guidance marker is selected from a set of guidance markers including the first guidance marker 421 and the second guidance marker 423. The total score of 44/60 for the first guidance marker 421 can be compared with the score of 53/60 for the second guidance marker 423 for selection. The selection can be based on which score is higher. In this example, the score 53/60 of the second guidance marker 423 exceeds the score 44/60 of the first guidance marker 421. Thus, the second guidance marker 423 is selected for use in navigating along the path. Navigational assistance data based on the second guidance marker 423 can then be determined and a presentation of the navigation assistance data can be provided.

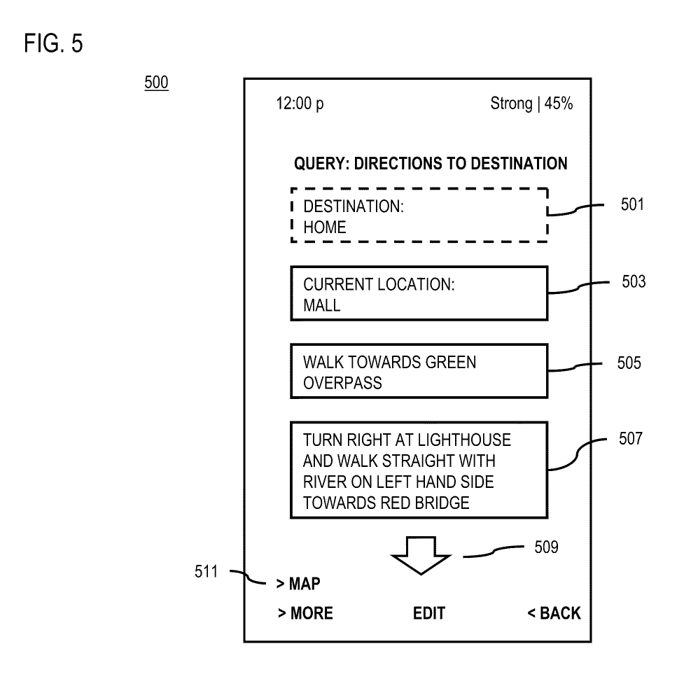

FIG. 5 is a diagram of a user interface 500 utilized in the processes of FIG. 4, according to one embodiment. The user interface 500 can include various methods of presentation. For example, the user interface 500 can have outputs including a visual component (e.g., a screen), an audio component, and a physical component (e.g., vibrations), etc. User inputs can include a touch-screen interface, a scroll-and-click interface, a button interface, a microphone, etc. The user can be provided an area or text box 501 to specify a destination. The user may select a home point as the destination. The user interface 500 may also display a current location 503, which could be descriptive as to what guidance markers are nearby the user or be other location information (e.g., an address, GPS coordinates, etc.). The user interface 500 may also present guidance information 505, 507. The guidance information can include a description of the guidance marker (e.g., green overpass) and a relationship of the user's current location to the guidance marker (e.g., walk towards). In some embodiments, a first guidance 505 can be provided for the user and a second guidance 507 can be provided for the user based on a completion of the first guidance 505. In certain embodiments, multiple guidance markers may be used to provide the guidance information to the user. Moreover, the user interface 500 may show additional information via scrolling 509. Additionally, the user interface may include an option to display a map 511. An exemplary map that may be displayed is provided in FIG. 2.

The processes described herein for providing navigational assistance using guidance markers may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

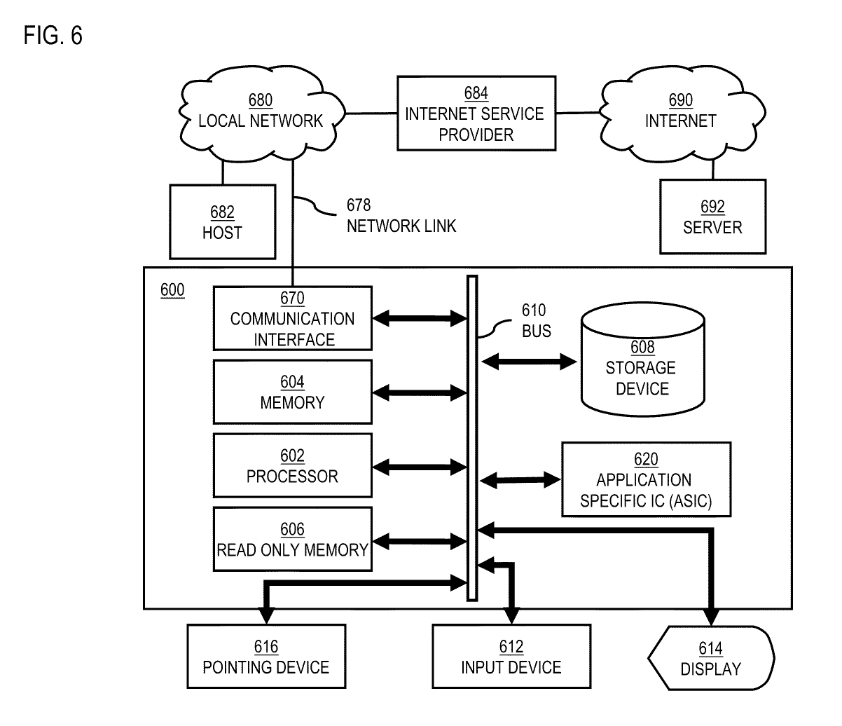

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to provide navigational assistance using guidance markers as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of providing navigational assistance using guidance markers.

A bus 610 includes one or more parallel conductors of information so that information is transferred quickly among devices coupled to the bus 610. One or more processors 602 for processing information are coupled with the bus 610.

A processor 602 performs a set of operations on information as specified by computer program code related to providing navigational assistance using guidance markers. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for providing navigational assistance using guidance markers. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for providing navigational assistance using guidance markers, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for providing navigational assistance using guidance markers to the UE 101.

The term computer-readable medium is used herein to refer to any medium that participates in providing information to processor 602, including instructions for execution. Such a medium may take many forms, including, but not limited to, non-volatile media, volatile media and transmission media. Non-volatile media include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set 700 upon which an embodiment of the invention may be implemented. Chip set 700 is programmed to provide navigational assistance using guidance markers as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 700, or a portion thereof, constitutes a means for performing one or more steps of providing navigational assistance using guidance markers.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to provide navigational assistance using guidance markers. The memory 705 also stores the data associated with or generated by the execution of the inventive steps.

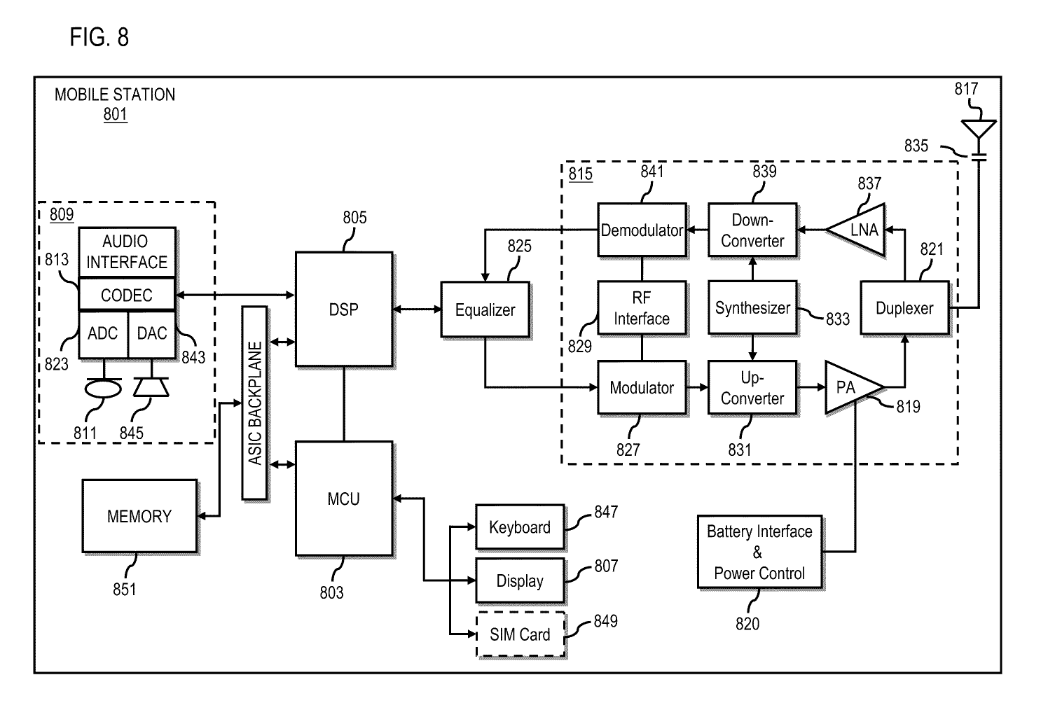

FIG. 8 is a diagram of exemplary components of a mobile terminal (e.g., handset) for communications, which is capable of operating in the system of FIG. 1, according to one embodiment. In some embodiments, mobile terminal 800, or a portion thereof, constitutes a means for performing one or more steps of providing navigational assistance using guidance markers. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of providing navigational assistance using guidance markers. The display 8 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to provide navigational assistance using guidance markers. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving one or more parameters associated with a guidance marker;
determining a score for the guidance marker using the one or more parameters; and
selecting the guidance marker based, at least in part, on the score for use in navigating along a path.

2. A method of claim 1, wherein the one or more parameters include a distance parameter, a visibility parameter, an obstruction parameter, a path parameter or a combination thereof

3. A method of claim 1, further comprising:
determining at least one other score for at least one other guidance marker; and
comparing the at least one other score with the score, wherein the guidance marker is selected based on the comparison.

4. A method of claim 1, further comprising:
determining a suitability weighting for the guidance marker based, at least in part, on a type of travel along the path,
wherein the score is determined based, at least in part, on the suitability weighting.

5. A method of claim 1, further comprising:
receiving a starting point and a destination point;
determining the path based, at least in part, on the starting point and destination point;
associating the guidance marker to the path;
determining navigational assistance data based, at least in part, on the guidance marker and the association; and
causing, at least in part, actions leading to the presentation of the navigational assistance data on a device.

6. A method of claim 1, further comprising:
receiving a starting point and a destination point;
determining the path based, at least in part, on the starting point and destination point;
determining a need for at least one other path based on the score;
determining the at least one other path based on the guidance marker; and
determining navigational assistance data based, at least in part, on the at least one other path and the guidance marker.

7. A method of claim 1, wherein the score comprises a sum of parameter scores for each of the parameters and one or more of the parameter scores are based, at least in part, on guidance marker context information relevant to the guidance marker.

8. A method of claim 7, wherein the guidance marker context information includes weather information, time information, traffic information, or a combination thereof.

9. An apparatus comprising:
at least one processor; and
at least one memory including computer program code,
the at least one memory and the computer program code configured to, with the at least one processor, cause the apparatus to perform at least the following,
receive one or more parameters associated with a guidance marker;
determine a score for the guidance marker using the one or more parameters; and
select the guidance marker based, at least in part, on the score for use in navigating along a path.

10. An apparatus of claim 9, wherein the one or more parameters include a distance parameter, a visibility parameter, an obstruction parameter, a path parameter or a combination thereof

11. An apparatus of claim 9, wherein the apparatus is further caused, at least in part, to:
determine at least one other score for at least one other guidance marker; and
compare the at least one other score with the score, wherein the guidance marker is selected based on the comparison.

12. An apparatus of claim 9, wherein the apparatus is further caused, at least in part, to:
determine a suitability weighting for the guidance marker based, at least in part, on a type of travel along the path,
wherein the score is determined based, at least in part, on the suitability weighting.

13. An apparatus of claim 9, wherein the apparatus is further caused, at least in part, to:
receive a starting point and a destination point;
determine the path based, at least in part, on the starting point and destination point;
associate the guidance marker to the path;
determine navigational assistance data based, at least in part, on the guidance marker and the association; and
cause, at least in part, actions leading to the presentation of the navigational assistance data on a device.

14. An apparatus of claim 9, wherein the apparatus is further caused, at least in part, to:
receive a starting point and a destination point;
determine the path based, at least in part, on the starting point and destination point;
determine a need for at least one other path based on the score;
determine the at least one other path based on the guidance marker; and
determine navigational assistance data based, at least in part, on the at least one other path and the guidance marker.

15. An apparatus of claim 9, wherein the score comprises a sum of parameter scores for each of the parameters and one or more of the parameter scores are based, at least in part, on guidance marker context information relevant to the guidance marker.

16. An apparatus of claim 15, wherein the guidance marker context information includes weather information, time information, traffic information, or a combination thereof.

17. A computer-readable storage medium carrying one or more sequences of one or more instructions which, when executed by one or more processors, cause an apparatus to at least perform the following steps:
receiving one or more parameters associated with a guidance marker;
determining a score for the guidance marker using the one or more parameters; and
selecting the guidance marker based, at least in part, on the score for use in navigating along a path.

18. A computer-readable storage medium of claim 17, wherein the apparatus is caused, at least in part, to further perform:
determining at least one other score for at least one other guidance marker; and
comparing the at least one other score with the score, wherein the guidance marker is selected based on the comparison.

19. A computer-readable storage medium of claim 17, wherein the apparatus is caused, at least in part, to further perform:
receiving a starting point and a destination point;
determining the path based, at least in part, on the starting point and destination point;
associating the guidance marker to the path;
determining navigational assistance data based, at least in part, on the guidance marker and the association; and
causing, at least in part, actions leading to the presentation of the navigational assistance data on a device.

20. A computer-readable storage medium of claim 17, wherein the apparatus is caused, at least in part, to further perform:
receiving a starting point and a destination point;
determining the path based, at least in part, on the starting point and destination point;
determining a need for at least one other path based on the score;
determining the at least one other path based on the guidance marker; and
determining navigational assistance data based, at least in part, on the at least one other path and the guidance marker.
